(19) United States
(12) Patent Application Publication
(10) Pub. No.: US 2024/0182622 A1
(43) Pub. Date: Jun. 6, 2024

(54) BLOCK COPOLYMERS, MEMBRANES, AND METHODS

(71) Applicant: The Florida State University Research Foundation, Inc., Tallahassee, FL (US)

(72) Inventor: Justin G. Kennemur, Tallahassee, FL (US)

(21) Appl. No.: 18/508,483

(22) Filed: Nov. 14, 2023

Related U.S. Application Data
(60) Provisional application No. 63/383,593, filed on Nov. 14, 2022.

(51) Int. Cl. C08F 293/00; B01D 71/80; C08F 212/08; C08F 220/18; C08F 226/06; C08F 228/02

(52) U.S. Cl. CPC C08F 293/005; B01D 71/80; C08F 212/08; C08F 220/1804; C08F 226/06; C08F 228/02; B01D 2325/42; C08F 2438/03

(57) ABSTRACT

The present disclosure provides block copolymers, thin films including block copolymers, and methods for forming block copolymers and thin films. The block copolymers, due to self-assembly or otherwise, may include one or more regions. The one or more regions may permit a thin film including a block copolymer to be used as a nanostructured membrane.

### CROSS-REFERENCE TO RELATED APPLICATIONS

This application claims the benefit of priority to U.S. Provisional Application No. 63/383,593 filed Nov. 14, 2022, the disclosure of which is incorporated herein by reference in its entirety.

### BACKGROUND

Charged mosaics are systems with coexisting yet separate domains of positive and negative charge. As membranes, these systems may have unique transport properties compared to typical ion exchange membranes that include one type of single ion conductor (positive or negative). For example, membranes with channels of polycations may allow preferential permeation of anions over cations in a solution, leading to a loss of electroneutrality and the problem of salt rejection.

A membrane with coexisting “zones” rich in either polyanions or polycations may allow the simultaneous transport of both cations and anions, respectively, without violating macroscopic electroneutrality. Therefore, an ion current could be established between the individual exchange elements that may accelerate salt transport through the membrane and deter permeation of neutral species of similar size.

One of the limitations preventing the development and understanding of charged mosaic technologies, particularly at the nanofiltration scale, includes the need to identify new materials and methods to create them. This is in addition to other properties that greatly affect ion transport, such as the morphology and size of the mosaic pattern.

Autonomous block copolymer (BCP) self-assembly can be used to create large area nanoscale templates with tunable size and morphology, but efforts to synthesize charged mosaics from self-assembled BCPs stalled decades ago (see, e.g., Fujimoto, T. et al. Journal of membrane science 1984, 20, 313-324; Nunes, S. P. et al., Ind. Eng. Chem. Res. 2013, 52, 993-1003; and Ishizu, K. et al., Journal of Polymer Science: Polymer Chemistry Edition 1985, 23, 1099-1108).

There remains a need for new block copolymers, thin films of block copolymers, and methods for making block copolymers that may self-assemble into desirable physical configurations (e.g., configurations having at least three regions), be easily ionized, have improved physical properties, or a combination thereof.

### SUMMARY

Provided herein are methods for making block copolymers and block copolymers, aspects of which may self-assemble into structures having at least three regions (e.g., at least three discrete regions), be easily ionized, have improved physical properties, or a combination thereof. When at least three regions are present, one of the regions may impart one or more desired physical properties to the material, prevent two or more other regions from contacting each other, or a combination thereof. In some aspects, the block copolymers, especially thin films of the block copolymers, have one or more nanostructured charge mosaic surfaces. These nanostructure charge mosaic surfaces may be formed, at least in part, through thin film directed self-assembly of a neutral block copolymer followed by one or more selective treatments, e.g., vapor treatments, that ionize one or more particular domains.

In one aspect, a block copolymer is provided of formula A, formula B, formula C, formula D, formula E, or formula F:

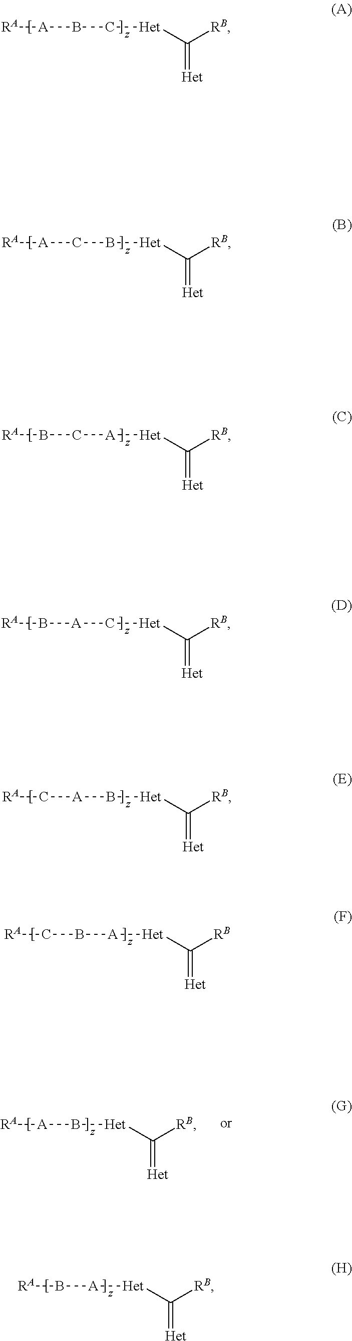

wherein:
R^{A} is independently selected at each occurrence selected from

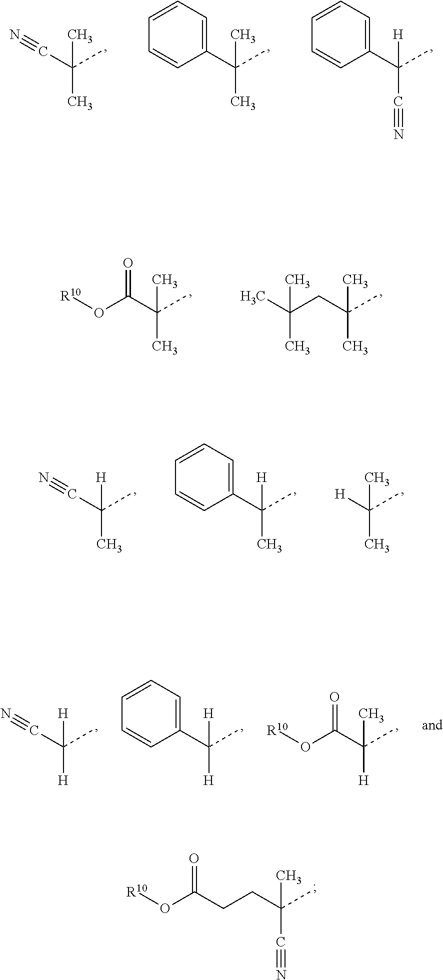

R¹⁰ is independently selected at each occurrence from hydrogen and C₁-C₂₀ hydrocarbyl;
R^{B} is independently selected at each occurrence from selected from

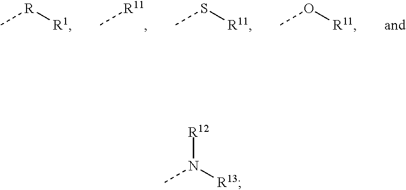

R is independently selected at each occurrence from divalent C₁ hydrocarbyl, nitrogen, oxygen, and sulfur;
R¹ is independently selected at each occurrence from C₁-C₂₀ hydrocarbyl;
R¹¹ is independently selected at each occurrence from C₁-C₂₀ hydrocarbyl;
R¹² is independently selected at each occurrence from hydrogen and C₁-C₂₀ hydrocarbyl;
R¹³ is independently selected at each occurrence from C₁-C₂₀ hydrocarbyl;
or R¹² and R¹³ are brought together with the carbon to which they are attached to form a 5- to 6-membered heterocycle or 5- to 10-membered monocyclic or bicyclic heteroaryl;
z is at least 1;
Het is independently selected at each occurrence from NH, O, or S;
A is

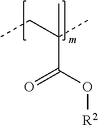

wherein each R² is independently selected at each occurrence from hydrogen and C₁-C₂₀ hydrocarbyl,
B is

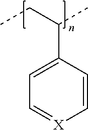

wherein X is independently selected at each occurrence from N or N⁺R³, wherein R³ is independently selected at each occurrence from a monovalent C₁-C₂₀ hydrocarbyl or a divalent C₁-C₂₀ hydrocarbyl crosslinker,
C is

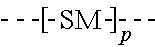

wherein SM is a stabilizer monomer, and
m, n, and p are independently selected from an integer from 1 to 10,000.

In some aspects, R^{A} is

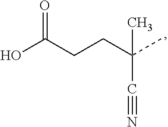

and
R^{B} is

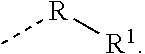

In some aspects, R¹ is unsubstituted linear C₁₂ hydrocarbyl.

In some aspects, R² is tert-butyl.

In some aspects, C is

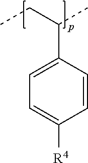

wherein R⁴ is independently selected at each occurrence from hydrogen and C₁-C₂₀ hydrocarbyl.

In some aspects, R⁴ is hydrogen. In other aspects, R⁴ is tert-butyl.

In some aspects, X is N. In other aspects, X is N⁺R³, wherein R³ is a divalent C₁-C₂₀ hydrocarbyl crosslinker.

In some aspects, the block copolymer has the structure

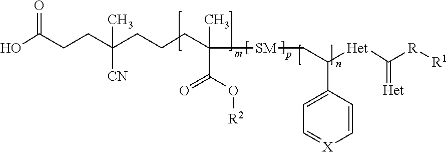

In some aspects, the block copolymer has the structure

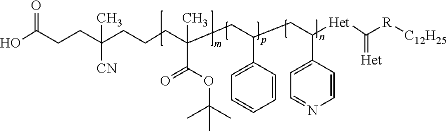

In some aspects, a thin film is provided comprising a block copolymer described herein. In some aspects, the thin film comprises a plurality of first regions consisting of a poly-4-vinylpyridine portion of the block copolymer. In some aspects, the thin film comprises a plurality of second regions consisting of a stabilizing monomer portion of the block copolymer. In some aspects, the second regions are circumjacent to the first regions. In some aspects, the plurality of first regions and the plurality of second regions are dispersed in a matrix comprising a poly-t-butylmethacrylate portion of the block copolymer.

In another aspect, a method is provided of forming a thin film of a self-assembled block copolymer, the method comprising:
(i) providing a block copolymer described herein,
(ii) disposing the block copolymer on a substrate to form the thin film.

In another aspect, a method is provided of producing a block copolymer comprising
(i) providing a compound of formula (I-a)

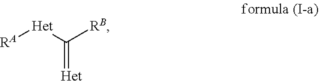

wherein
R^{A} is independently selected at each occurrence selected from

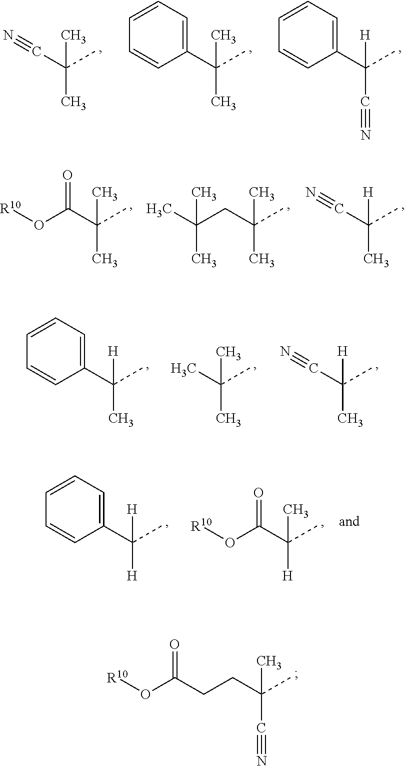

R¹⁰ is independently selected at each occurrence from hydrogen and C₁-C₂₀ hydrocarbyl;
R^{B} is independently selected at each occurrence from selected from

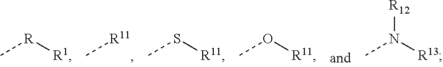

R is independently selected at each occurrence from divalent C₁ hydrocarbyl, nitrogen, oxygen, and sulfur;
R¹ is independently selected at each occurrence from C₁-C₂₀ hydrocarbyl;
R¹¹ is independently selected at each occurrence from C₁-C₂₀ hydrocarbyl;
R¹² is independently selected at each occurrence from hydrogen and C₁-C₂₀ hydrocarbyl; and
R¹³ is independently selected at each occurrence from C₁-C₂₀ hydrocarbyl;
or R¹² and R¹³ are brought together with the carbon to which they are attached to form a 5- to 6-membered heterocycle or 5- to 10-membered monocyclic or bicyclic heteroaryl;
(ii) providing a compound of formula (II)

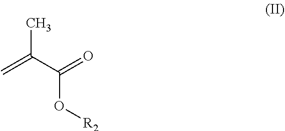

wherein R² is selected from hydrogen and C₁-C₂₀ hydrocarbyl;
(iii) providing a stabilizer monomer;
(iv) contacting the compound of formula (I-a), the compound of formula (II), and the stabilizer monomer to form an intermediate polymer; and
(v) contacting the intermediate polymer with a vinylpyridine to form the block copolymer.

In some aspects, the compound of formula (I-a) is a compound of formula (I)

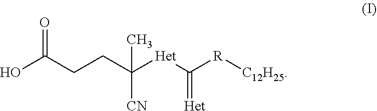

In some aspects, the stabilizer monomer is selected from styrene, a styrenic derivative, a C₂-C₆ alkene, polyvinyl halide, or a combination thereof.

The details of one or more aspects of the disclosure are set forth in the accompanying drawings and the description below. Other features, objects, and advantages of the disclosure will be apparent from the description, the drawings, and the claims.

Additional aspects will be set forth in part in the description which follows, and in part will be obvious from the description, or may be learned by practice of the aspects described herein. The advantages described herein may be realized and attained by means of the elements and combinations particularly pointed out in the appended claims. It is to be understood that both the foregoing general description and the following detailed description are exemplary and explanatory only and are not restrictive.

### DESCRIPTION OF DRAWINGS

FIG. 1 depicts an exemplary thin film as described herein.

### DETAILED DESCRIPTION

Provided herein are block copolymers, thin films that include block copolymers, and methods for forming block copolymers and/or thin films that include block copolymers. The block copolymers and films described herein may be produced and/or characterized by techniques described in U.S. Pat. No. 11,459,420, which is incorporated herein by reference.

### Methods

In some aspects, the methods for producing block copolymers include providing a compound of formula (I-a)

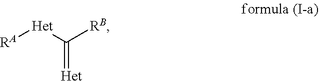

wherein
R^{A} is independently selected at each occurrence selected from

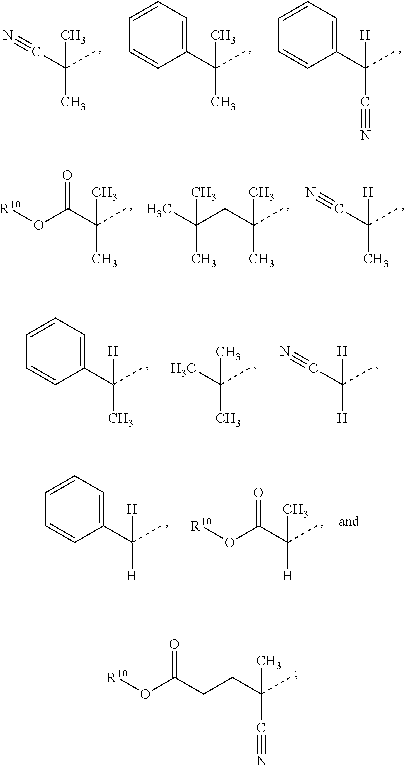

R¹⁰ is independently selected at each occurrence from hydrogen and C₁-C₂₀ hydrocarbyl;
R^{B} is independently selected at each occurrence from selected from

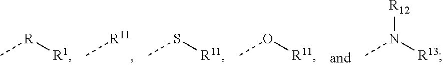

R is independently selected at each occurrence from divalent C₁ hydrocarbyl, nitrogen, oxygen, and sulfur;
R¹ is independently selected at each occurrence from C₁-C₂₀ hydrocarbyl;
R¹¹ is independently selected at each occurrence from C₁-C₂₀ hydrocarbyl;
R¹² is independently selected at each occurrence from hydrogen and C₁-C₂₀ hydrocarbyl; and
R¹³ is independently selected at each occurrence from C₁-C₂₀ hydrocarbyl;
or R¹² and R¹³ are brought together with the carbon to which they are attached to form a 5- to 6-membered heterocycle or 5- to 10-membered monocyclic or bicyclic heteroaryl.

In some aspects, the compound of formula (I-a) is a compound of formula (I), wherein
R^{A} is

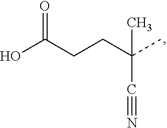

and
R^{B} is

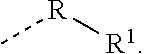

In some aspects of formula (I) depicting a carboxylic acid moiety, the formula encompasses and reads on the conjugate base of the carboxylic acid moiety, or, in other words, a carboxylate moiety.

In some aspects, R¹ of formula (I) is an aryl C₁-C₂₀ hydrocarbyl, such as a substituted aryl C₁-C₂₀ hydrocarbyl, for example, dithiobenzoate. In some aspects, R¹ of formula (I) is a linear C₁-C₂₀ hydrocarbyl, a linear C₅-C₁₅ hydrocarbyl, or a linear C₁₀-C₁₅ hydrocarbyl. In some aspects, R¹ of formula (I) is an unsubstituted linear C₁-C₂₀ hydrocarbyl, an unsubstituted linear C₅-C₁₅ hydrocarbyl, or an unsubstituted linear C₁₀-C₁₅ hydrocarbyl.

In some aspects, R1 is an unsubstituted linear C₁₂ hydrocarbyl, and the compound of formula (I) has the following structure:

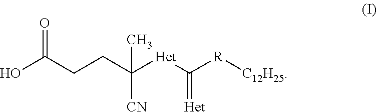

In some aspects, the compound of formula (I) is 4-cyano-4-[(dodecylsulfanylthiocarbonyl)sulfanyl]pentanoic acid (CDPA):

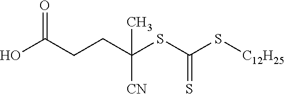

In some aspects, the methods include providing a compound of formula (II)—

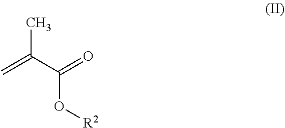

wherein R² is selected from hydrogen and C₁-C₂₀ hydrocarbyl.

In some aspects, R² of formula (II) is a branched C₁-C₁₀ hydrocarbyl, a branched C₁-C₅ hydrocarbyl, or a branched C₃-C₅ hydrocarbyl. In some aspects, R² of formula (II) is an unsubstituted branched C₁-C₁₀ hydrocarbyl, an unsubstituted branched C₁-C₅ hydrocarbyl, or an unsubstituted branched C₃-C₅ hydrocarbyl.

In some aspects, the compound of formula (II) is t-butylmethacrylate (tBMA):

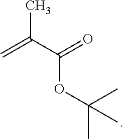

In some aspects, the methods include providing a stabilizer monomer. As used herein, the phrase “stabilizer monomer” refers to a monomer that (i) is inert upon polymerization and/or self-assembly, (ii) imparts one or more desirable physical properties to the block copolymers and/or thin films, (iii) is capable of forming a discrete region of a thin film, as described herein, or (iv) a combination thereof. The stabilizer monomer may be an inert monomer, such as an inert monomer that is hydrophobic, and remains hydrophobic upon being subjected to polymerization, self-assembly, and/or the treatments described herein. In some aspects, the stabilizer monomer includes a monomer of a thermoplastic. The stabilizer monomer may include styrene, a styrenic derivative, a C₂-C₆ alkene, polyvinyl halide, or a combination thereof. The phrase “styrenic derivative” refers to and includes all styrene derivatives known in the art, such as substituted styrene monomers. The substituted styrene monomers may be substituted at the 4-position (e.g., substituted at the 4-position with a C₁-C₂₀ hydrocarbyl or any of the other substituents described herein). In some aspects, the styrenic derivative comprises 4-t-butylstyrene.

In some aspects, the methods include contacting a compound of formula (I-a) (e.g., a compound of formula (I)), a compound of formula (II), and a stabilizer monomer to form an intermediate polymer. The intermediate polymer may or may not be isolated from a reaction medium in which the compound of formula (I-a), the compound of formula (II), and the stabilizer monomer are contacted.

A compound of formula (I-a) may be contacted with any mol ratio of a compound of formula (II). In some aspects, the mol ratio is about 1:200 to about 1:400 (formula (I-a):formula (II). In some aspects, the mol ratio is about 1:250 to about 1:350 (formula (I-a):formula (II)). In some aspects, the mol ratio is about 1:250 to about 1:300 (formula (I-a):formula (II)). In some aspects, the mol ratio is about 1:270 to about 1:290 (formula (I-a):formula (II)). In some aspects, the mol ratio is about 1:280 (formula (I-a):formula (II)). In some aspects, the ratio is any ratio between any two foregoing values or any subrange formed by any two foregoing values.

A compound of formula (II) may be contacted with any mol ratio of a stabilizer monomer. In some aspects, the compound of formula (II) is contacted with a mol ratio of the stabilizer monomer, wherein the mol ratio is about 1:10 to about 10:1, about 3:10 to about 10:3, about 5:10 to about 10:5, about 8:10 to about 10:8, or about 1:1 (formula (II):stabilizer monomer), any ratio between any two foregoing values, or any subrange formed by any two foregoing values.

In some aspects, the methods include contacting an intermediate polymer with a vinylpyridine, such as 4-vinylpyridine, to form a block copolymer. An intermediate polymer may be contacted with any mol ratio of vinylpyridine. In some aspects, the mol ratio is about 1:400 to about 1:600 (intermediate polymer:vinylpyridine). In some aspects, the mol ratio is about 1:450 to about 1:550 (intermediate polymer:vinylpyridine). In some aspects, the mol ratio is about 1:480 to about 1:520 (intermediate polymer:vinylpyridine). In some aspects, the mol ratio is about 1:500 (intermediate polymer:vinylpyridine). In some aspects, the contacting of an intermediate polymer with vinylpyridine occurs in the presence of a radical initiator, such as azobisisobutyronitrile (AIBN).

Also provided herein are methods of forming a thin film of a block copolymer, or a thin film that includes a block copolymer. The thin films may include a thin film of a self-assembled block copolymer. As used herein the phrase “self-assembled block copolymer” refers to a block copolymer in which at least a portion of the block copolymer (e.g., a homopolymer block thereof) assumes, at any point, a particular physical configuration, such as the “hexagonally-packed cylinders” that are present in some aspects herein.

In some aspects, the methods include providing a block copolymer (BCP) having one or more of the following structures—

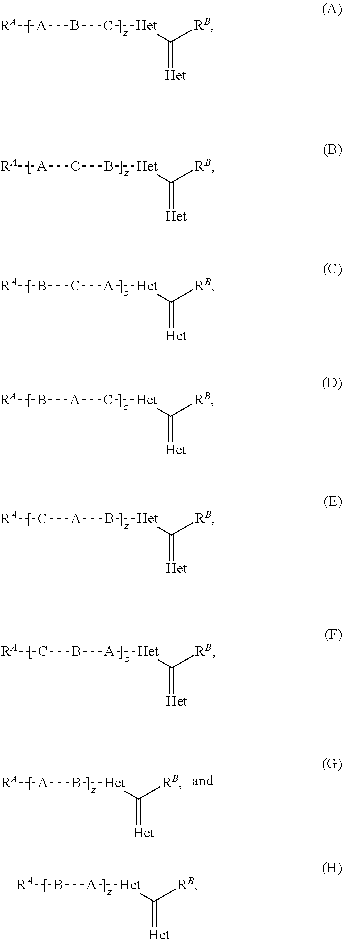

wherein:
R^{A} is independently selected at each occurrence selected from

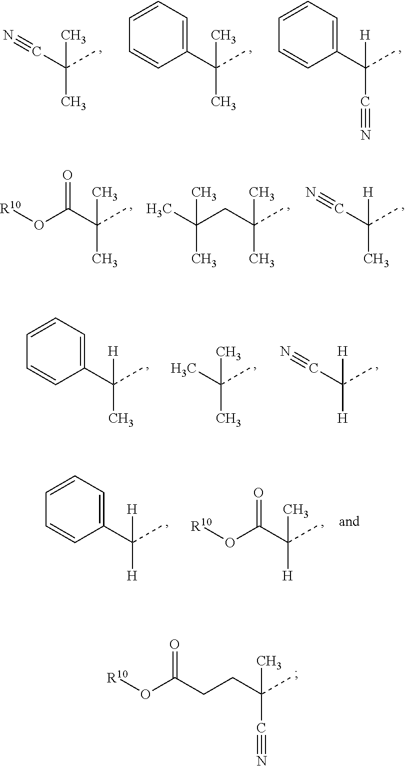

R¹⁰ is independently selected at each occurrence from hydrogen and C₁-C₂₀ hydrocarbyl;
R^{B} is independently selected at each occurrence from selected from

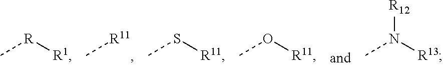

R is independently selected at each occurrence from divalent C₁ hydrocarbyl, nitrogen, oxygen, and sulfur;
R¹ is independently selected at each occurrence from C₁-C₂₀ hydrocarbyl;
R¹¹ is independently selected at each occurrence from C₁-C₂₀ hydrocarbyl;
R¹² is independently selected at each occurrence from hydrogen and C₁-C₂₀ hydrocarbyl;
R¹³ is independently selected at each occurrence from C₁-C₂₀ hydrocarbyl;
or R¹² and R¹³ are brought together with the carbon to which they are attached to form a 5- to 6-membered heterocycle or 5- to 10-membered monocyclic or bicyclic heteroaryl;
z is at least 1;
Het is independently selected at each occurrence from NH, O, or S;
A is

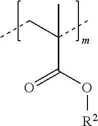

wherein each R² is independently selected at each occurrence from hydrogen and C₁-C₂₀ hydrocarbyl,
B is

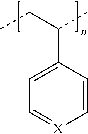

wherein X is independently selected at each occurrence from N or N⁺R³, wherein R³ is independently selected at each occurrence from a monovalent C₁-C₂₀ hydrocarbyl or a divalent C₁-C₂₀ hydrocarbyl crosslinker,
C is

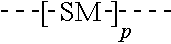

wherein SM is a stabilizer monomer, and
m, n, and p are independently selected from an integer from 1 to 10,000; and
(ii) disposing the block copolymer on a substrate to form the thin film.

The substrate may be formed of any material, such as an inert material.

In some aspects, the methods include contacting a block copolymer or a thin film with a quaternizing agent, such as a haloalkyl. As used herein, the term “quaternize” refers to converting a pyridinyl nitrogen heteroatom to N⁺R³, as described herein. In some aspects, a block copolymer is contacted with an amount of a quaternizing agent, such as a haloalkyl, effective to quaternize at least one pyridinyl nitrogen to N⁺R³, wherein R³ is selected independently from a monovalent C₁-C₂₀ hydrocarbyl or a divalent C₁-C₂₀ hydrocarbyl crosslinker. As used herein, the term “haloalkyl” refers to any halo-substituted C₁-C₂₀ hydrocarbyl. The haloalkyl may be in the form of a vapor. In some aspects, the haloalkyl includes bromoethane. In some aspects, a block copolymer is contacted with an amount of a quaternizing agent, such as a haloalkyl, effective to quaternize at least 25 mol %, at least 50 mol %, at least 75 mol %, or at least 99 mol % of the pyridinyl nitrogens of a block copolymer to N⁺R³, wherein R³ is selected independently from a monovalent C1-C20 hydrocarbyl or a divalent C₁-C₂₀ hydrocarbyl crosslinker.

In some aspects, the methods include contacting a block copolymer or a thin film with a hydrolyzing agent, such as a halide (e.g., Cl⁻). As used herein, the term “hydrolyze” refers to converting an alkyl ether to a carboxylic acid or its conjugate base. In some aspects, the methods include contacting a block copolymer or a thin film with an amount of a hydrolyzing agent, such as a hydrogen halide, effective to hydrolyze at least one methacrylate monomer by converting at least one R² to hydrogen, as described herein. In some aspects, the methods include contacting a block copolymer or a thin film with an amount of a hydrolyzing agent, such as a hydrogen halide, effective to hydrolyze at least 25 mol %, at least 50 mol %, at least 75 mol %, or at least 99 mol % of the methacrylate monomers of a block copolymer by converting at least one R² to hydrogen, as described herein.

In some aspects, a block copolymer is quaternized, hydrolyzed, or both. When a block copolymer is both quaternized and hydrolyzed, these treatments may be performed sequentially, in any order, or at least partially simultaneously.

Variations on compounds used in the processes described herein can include the addition, subtraction, or movement of various constituents as described for each compounds. Similarly, when one or more chiral centers are present in a molecule, the chirality of the molecule can be changed. Additionally, the synthesis of the compounds used in these processes can involve the protection of various chemical groups, and further the compounds prepared by the disclosed processes may be subsequently deprotected as appropriate. The use of protection and deprotection, and the selection of appropriate protecting groups, would be readily known to one skilled in the art. “Protecting group”, as used herein, refers to any convention functional group that allows one to obtain chemoselectivity in a subsequent chemical reaction. Protecting groups are described, for example, in Peter G. M. Wuts, Greene's Protective Groups in Organic Synthesis, 5^{th} Ed., Wiley & Sons, 2014. For a particular compound and/or a particular chemical reaction, a person skilled in the art knows how to select and implement appropriate protecting groups and their associated synthetic methods. Examples of amine protecting groups include acyl and alkoxy carbonyl groups, such a t-butoxycarbonyl (BOC) and [2-(trimethylsilyl)ethoxy]methoxy (SEM). Examples of carboxyl protecting groups include C₁-C₆ alkoxy groups, such as methyl, ethyl, and t-butyl. Examples of alcohol protecting groups include benzyl, trityl, silyl ethers, and the like.

The described processes, or reactions to produce the compounds used in the described processes, can be carried out in solvents indicated herein, or in solvents which can be selected by one of skill in the art of organic synthesis. Solvents can be substantially nonreactive with the starting materials (reactants), intermediates, or products under the conditions at which the reaction is carried out, i.e., temperature and pressure. Reactions can be carried out in one solvent or a mixture of more than one solvent. Product or intermediate formation can be monitored according to any suitable method known in the art. For example, product formation can be monitored by spectroscopic means, such as nuclear magnetic resonance spectroscopy (e.g., ¹H and ¹³C), infrared spectroscopy, spectrophotometry (e.g., UV-visible), or mass spectrometry, or by chromatography such as high performance liquid chromatography (HPLC) or thin layer chromatography (TLC).

### Block Copolymers and Thin Films

Also provided herein are block copolymers, including block copolymers capable of self assembly. In some aspects, the block copolymer is of one or more of formula A, formula B, formula C, formula D, formula E, and formula F:

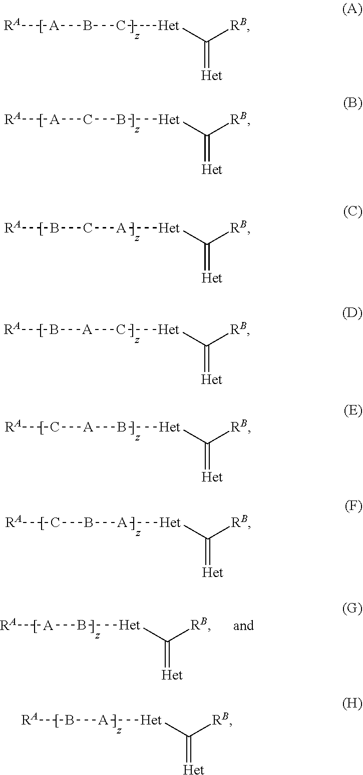

wherein:
R^{A} is independently selected at each occurrence selected from

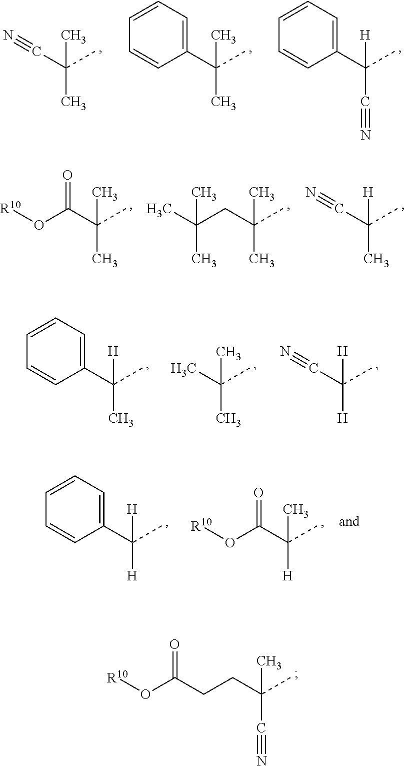

R¹⁰ is independently selected at each occurrence from hydrogen and C₁-C₂₀ hydrocarbyl;
R^{B} is independently selected at each occurrence from selected from

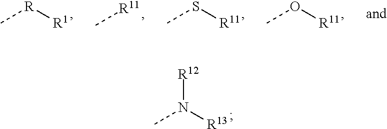

R is independently selected at each occurrence from divalent C₁ hydrocarbyl, nitrogen, oxygen, and sulfur;
R¹ is independently selected at each occurrence from C₁-C₂₀ hydrocarbyl;
R¹¹ is independently selected at each occurrence from C₁-C₂₀ hydrocarbyl;
R¹² is independently selected at each occurrence from hydrogen and C₁-C₂₀ hydrocarbyl;
R¹³ is independently selected at each occurrence from C₁-C₂₀ hydrocarbyl;
or R¹² and R¹³ are brought together with the carbon to which they are attached to form a 5- to 6-membered heterocycle or 5- to 10-membered monocyclic or bicyclic heteroaryl;
z is at least 1;
Het is independently selected at each occurrence from NH, O, or S;
A is

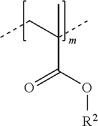

wherein each R² is independently selected at each occurrence from hydrogen and C₁-C₂₀ hydrocarbyl,
B is

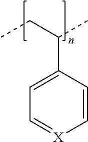

wherein X is independently selected at each occurrence from N or N⁺R³, wherein R³ is independently selected at each occurrence from a monovalent C₁-C₂₀ hydrocarbyl or a divalent C₁-C₂₀ hydrocarbyl crosslinker,
C is

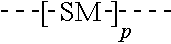

wherein SM is a stabilizer monomer, and
m, n, and p are independently selected from an integer from 1 to 10,000.

In some aspects, R^{A} is

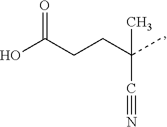

and
R^{B} is

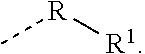

In some aspects, R^{B} is

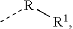

wherein R¹ is unsubstituted linear C₁₂ hydrocarbyl.

In some aspects, SM is a styrene. In some aspects, C is

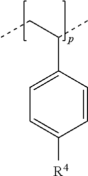

wherein R⁴ is independently selected at each occurrence from hydrogen and C₁-C₂₀ hydrocarbyl (e.g., ten-butyl). In some aspects, R⁴ is hydrogen. In some aspects, R⁴ is C₁-C₂₀ hydrocarbyl, for example tert-butyl.

In some aspects, X is N⁺R³, wherein R³ is a divalent C₁-C₂₀ hydrocarbyl crosslinker. In such aspects, R³ may bond two pyridine moieties together, and the binding may be intramolecular (i.e., two pyridine moieties of the same polymer macromolecule), intermolecular (i.e., two pyridine moieties of two different polymer macromolecules), or a combination thereof.

In some aspects, m is an integer from 200 to 400, n is an integer from 400 to 600, and p is an integer from 200 to 600.

In some aspects, m is an integer from about 100 to about 5,000, about 100 to about 4,000, about 100 to about 3,000, about 100 to about 2,000, about 100 to about 1,000, about 100 to about 600, about 100 to about 500, about 200 to about 400, about 200 to about 300, or about 280, any integer between any two foregoing values, or any subrange formed by any two foregoing values.

In some aspects, n is an integer from about 100 to about 5,000, about 100 to about 4,000, about 100 to about 3,000, about 100 to about 2,000, about 100 to about 1,000, about 200 to about 800, about 400 to about 600, about 450 to about 550, or about 500, any integer between any two foregoing values, or any subrange formed by any two foregoing values.

In some aspects, p is an integer from about 100 to about 5,000, about 100 to about 4,000, about 100 to about 3,000, about 100 to about 2,000, about 100 to about 1,000, about 200 to about 800, about 400 to about 600, about 450 to about 550, or about 500, any integer between any two foregoing values, or any subrange formed by any two foregoing values.

In some aspects, the ratio of m to n is about 10:1 to about 1:10, for example, about 10:1, about 9:1, about 8:1, about 7:1, about 6:1, about 5:1, about 4:1, about 3:1, about 2:1, about 1.5:1, about 1.25:1, about 1:1, about 1:1.25, about 1:1.5, about 1:2, about 1:3, about 1:4, about 1:5, about 1:6, about 1:7, about 1:8, about 1:9, about 1:10, any ratio between any two foregoing values, or any subrange formed by any two foregoing values.

In some aspects, the block copolymer is of one or more of the following formulae:

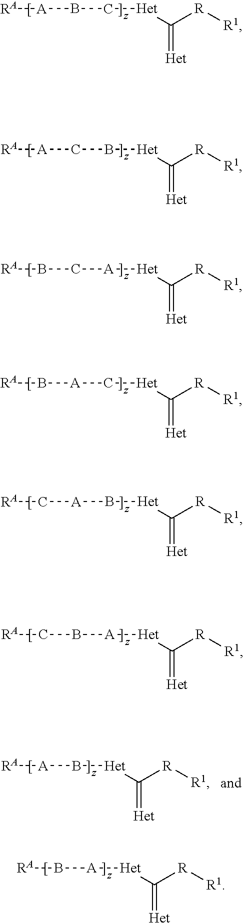

In some aspects, the block copolymer is of one or more of the following formulae:

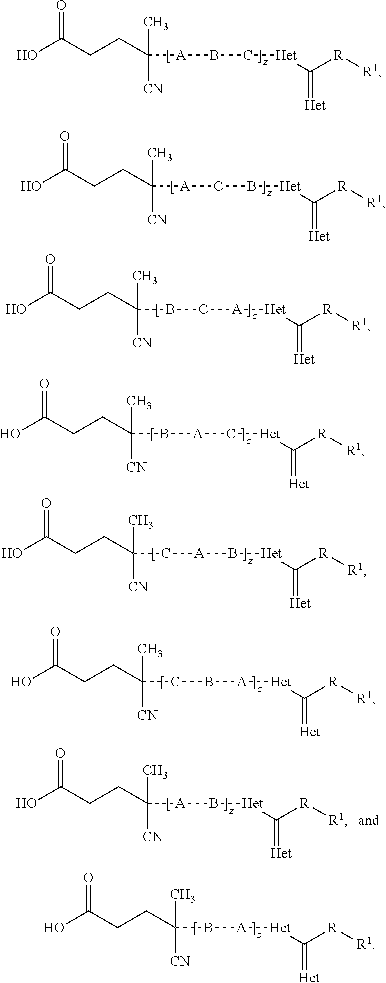

In some aspects, the block copolymer has the following structure:

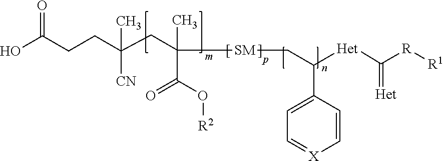

In some aspects, the block copolymer has the following structure:

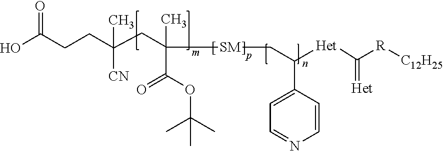

In some aspects, the block copolymer has the following structure:

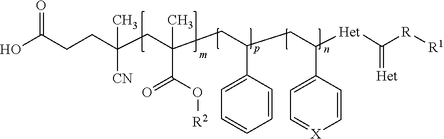

In some aspects, the block copolymer has the following structure:

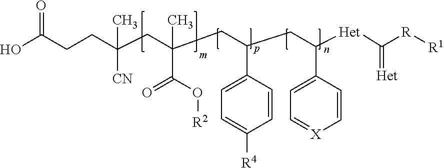

In some aspects, the block copolymer has the following structure:

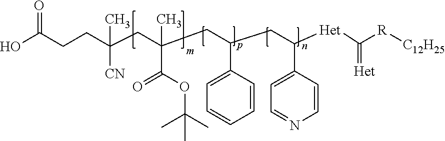

In some aspects, X is N⁺R³, wherein R³ is a divalent C₁-C₂₀ hydrocarbyl crosslinker, as depicted in the following formula:

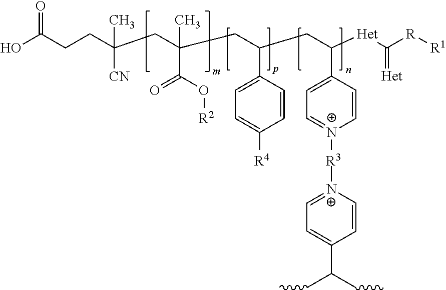

Also provided herein are thin films that include or consist of one or more of the block copolymers described herein. The films may have any thickness, such as 10 nm to 10 mm.

The thin films may include one or more regions that include a portion of a block copolymer, such as a homopolymer block of a block copolymer. The one or more regions may have any physical configuration, and the one or more regions may form via self-assembly of at least a portion of a block copolymer.

In some aspects, a thin film includes at least one first region that includes or consists of a polyvinylpyridine portion of the block copolymer. A polyvinylpyridine portion may include at least monomer wherein X is N⁺R³. In some aspects, the thin film includes a plurality of the first regions, and the first regions are in the form of hexagonally-packed cylinders.

In some aspects, a thin film includes at least one second region consisting of a stabilizing monomer portion of block copolymer. A thin film may include a plurality of the second regions. In some aspects, the second region(s) is/are circumjacent the first region(s).

In some aspects, the plurality of first regions and/or the plurality of second regions are dispersed in a matrix comprising a poly-t-butylmethacrylate portion of the block copolymer. The poly-t-butylmethacrylate portion may include at least one monomer wherein R² is hydrogen.

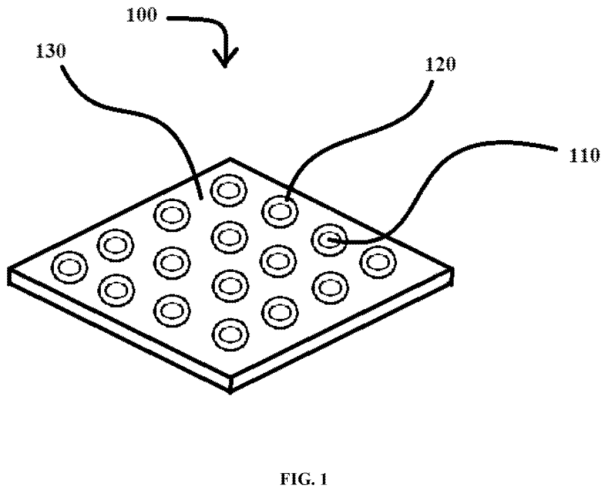

FIG. 1 depicts an exemplary thin film 100 that includes a plurality of first regions 110 that are in the shape of “cylinders” (which may be hexagonally-packed). The thin film 100 also includes a plurality of second regions 120. Each of the first regions 110 is encircled by a second region 120 in the exemplary thin film depicted at FIG. 1, and the pluralities of the first regions 110 and second regions 120 are dispersed in a third region, which is a matrix 130 formed of a monomer of the block copolymer. The thin film 100 of FIG. 1 may be formed of a block copolymer having one of the formulae described herein, and the plurality of first regions 110, the plurality of second regions 120, and the matrix 130 may be formed of the following monomers, wherein R², m, X, n, SM, and p are as defined herein:

| Exemplary Thin Film | 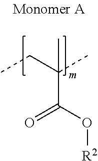 | 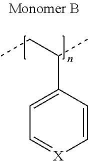 | 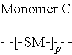 |
|---|---|---|---|
| 1 | First Regions 110 | Second Regions 120 | Matrix 130 |
| 2 | First Regions 110 | Matrix 130 | Second Regions |
| | | | 120 |
| 3 | Second Regions 120 | First Regions 110 | Matrix 130 |
| 4 | Second Regions 120 | Matrix 130 | First Regions |
| | | | 110 |
| 5 | Matrix 130 | First Regions 110 | Second Regions |
| | | | 120 |
| 6 | Matrix 130 | Second Regions 120 | First Regions |
| | | | 110 |

In the thin film of FIG. 1, monomer A may include at least one monomer wherein R² is hydrogen. Although hexagonally-packed cylinders are depicted at FIG. 1, other physical configurations of the first regions are envisioned.

Due to the presence of the at least one first region, the at least one second region, and the at least one third region, nanostructure surfaces may be created on one or more surfaces of the thin films described herein. The creation of nanostructure surfaces of opposite charge may permit the direct patterning of one or more additives on a thin film. The additives may include nanoparticles. The thin films may include anti-bacterial coatings.

### Additional Exemplary Aspects

In view of the described processes and compositions, hereinbelow are described certain more particularly and additionally described aspects of the disclosures. These particularly recited aspects should not, however, be interpreted to have any limiting effect on any different claims containing different or more general teachings described herein, or that the “particular” aspects are somehow limited in some way other than the inherent meanings of the language and formulas literally used therein.

Aspect 1. A method for preparing a block copolymer (BCP), the method comprising:
(i) providing a compound of formula (I)—

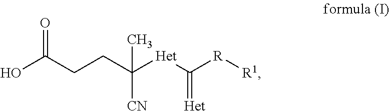

wherein R¹ is selected independently from a C₁-C₂₀ hydrocarbyl; Het is selected from the group consisting of nitrogen, oxygen, and sulfur; and R is selected from the group consisting of a divalent C₁ hydrocarbyl, nitrogen, oxygen, and sulfur;
(ii) providing a compound of formula (II)—

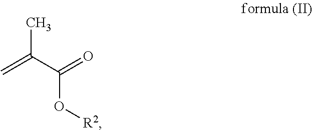

wherein R² is selected independently from a C₁-C₂₀ hydrocarbyl;
(iii) providing a stabilizer monomer;
(iv) contacting the compound of formula (I), the compound of formula (II), and the stabilizer monomer to form an intermediate polymer; and
(v) contacting the intermediate polymer and vinylpyridine to form the block copolymer.
   Aspect 2. The method of aspect 1, wherein R¹ is an aryl C₁-C₂₀ hydrocarbyl, such as a substituted aryl C₁-C₂₀ hydrocarbyl, for example, dithiobenzoate.
   Aspect 3. The method of aspect 1, wherein R¹ is an unsubstituted linear C₁₂ hydrocarbyl, and the compound of formula (I) has the following structure:

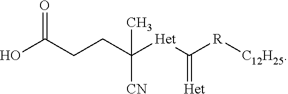

Aspect. 4 The method of any one of aspects 1 to 3, wherein the compound of formula (II) is t-butylmethacrylate (tBMA):

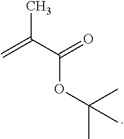

Aspect 5. The method of any one of aspects 1 to 4, wherein the stabilizer monomer comprises a monomer of a thermoplastic.
Aspect 6. The method of aspect 5, wherein the stabilizer monomer comprises styrene, a styrenic derivative, a C₂-C₆ alkene, polyvinyl halide, or a combination thereof.
Aspect 7. The method of aspect 6, wherein the styrenic derivative comprises styrene substituted at the 4-position, such as 4-t-butylstyrene.
Aspect 8. The method of any one of aspects 1 to 7, wherein—
(i) the compound of formula (I) is contacted with a mol ratio of the compound of formula (II), wherein the mol ratio is about 1:200 to about 1:400 (formula (I):formula (II)),
(ii) the compound of formula (II) is contacted with a mol ratio of the stabilizer monomer, wherein the mol ratio is about 1:10 to about 10:1 (formula (II):stabilizer monomer),
(iii) the intermediate polymer is contacted with a mol ratio of the vinylpyridine, wherein the mol ratio is about 1:400 to about 1:600 (intermediate polymer:vinylpyridine), or
(iv) a combination thereof.
   Aspect 9. The method of any one of aspects 1 to 8, wherein the contacting of the intermediate polymer and the vinylpyridine occurs in the presence of a radical initiator.
   Aspect 10. A block copolymer (BCP) of one or more of the following formulas:

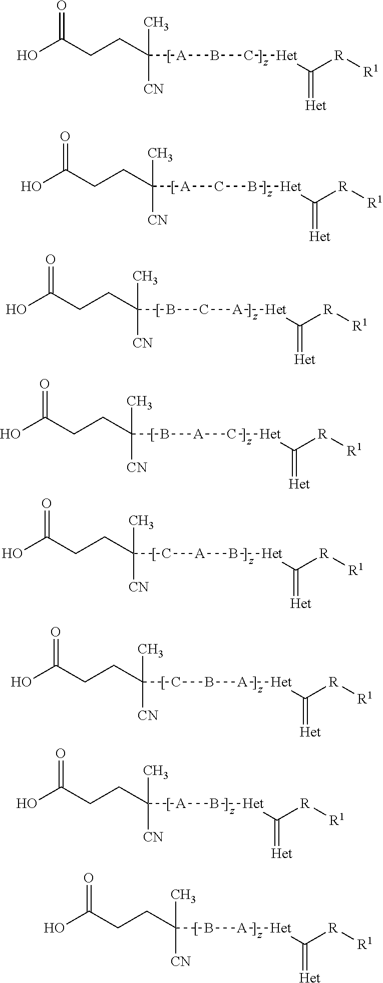

wherein z is at least 1,
wherein R¹ is selected independently from a C₁-C₂₀ hydrocarbyl,
wherein Het is selected from the group consisting of nitrogen, oxygen, and sulfur,
wherein R is selected from the group consisting of a divalent C₁ hydrocarbyl, nitrogen, oxygen, and sulfur,
wherein A is of the formula—

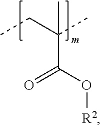

wherein each R² is selected independently from the group consisting of hydrogen and a C₁-C₂₀ hydrocarbyl,
wherein B is of the formula—

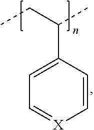

wherein each X is selected independently from N or N⁺R³, wherein R³ is selected independently from a monovalent C₁-C₂₀ hydrocarbyl or a divalent C₁-C₂₀ hydrocarbyl crosslinker,
wherein C is of the formula—

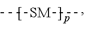

wherein SM is a stabilizer monomer, and
wherein m, n, and p are selected independently from an integer from 1 to 10,000.
   Aspect 11. A block copolymer (BCP) having a structure according to the following formula:

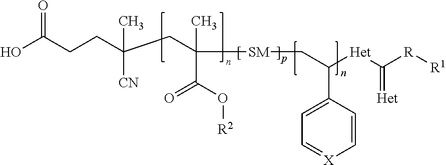

wherein—
R¹ is selected independently from a C₁-C₂₀ hydrocarbyl,
Het is selected from the group consisting of nitrogen, oxygen, and sulfur,
R is selected from the group consisting of a divalent C₁ hydrocarbyl, nitrogen, oxygen, and sulfur,
SM is a stabilizer monomer,
each R² is selected independently from the group consisting of hydrogen and a C₁-C₂₀ hydrocarbyl,
each X is selected independently from N or N⁺R³, wherein each R³ is selected independently from a monovalent C₁-C₂₀ hydrocarbyl or a divalent C₁-C₂₀ hydrocarbyl crosslinker, and
m, n, and p are selected independently from an integer from 1 to 10,000.
   Aspect 12. The block copolymer of aspect 11, wherein R¹ is an unsubstituted linear C₁₂ hydrocarbyl, R² is t-butyl, X is N, and the block copolymer has the following structure:

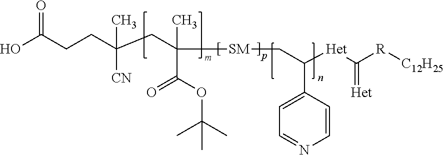

Aspect 13. The block copolymer of aspect 11, wherein SM is styrene, and block copolymer has the following structure:

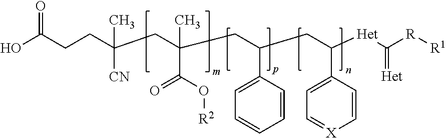

Aspect 14. The block copolymer of aspect 13, wherein SM is styrene, R¹ is an unsubstituted linear C₁₂ hydrocarbyl, R² is t-butyl, X is N, and the block copolymer has the following structure:

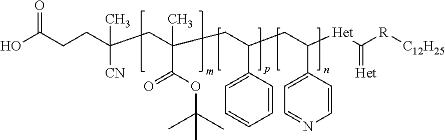

Aspect 15. The block copolymer of aspect 11, wherein SM is a styrenic derivative substituted at the 4-position with R⁴, wherein R⁴ is selected from hydrogen and a C₁-C₂₀ hydrocarbyl (e.g., t-butyl), and the block copolymer has the following structure:

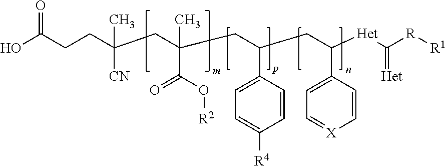

Aspect 16. The block copolymer of any one of aspects 10 to 15, wherein m is an integer from 200 to 400, n is an integer from 400 to 600, and p is an integer from 200 to 600.
Aspect 17. A thin film comprising the block copolymer of any one of aspects 10 to 16.
Aspect 18. The thin film of aspect 17, wherein the thin film comprises at least one first region consisting of a poly-4-vinylpyridine portion of the block copolymer.
Aspect 19. The thin film of aspect 18, wherein the poly-4-vinylpyridine portion comprises at least one monomer wherein X is N⁺R³.
Aspect 20. The thin film of any one of aspects 17 to 19, wherein the thin film comprises a plurality of the first regions in the form of cylinders, such as hexagonally-packed cylinders.
Aspect 21. The thin film of any one of aspects 17 to 20, wherein the thin film comprises at least one second region consisting of a stabilizing monomer portion of the block copolymer.
Aspect 22. The thin film of aspect 21, wherein the thin film comprises a plurality of the second regions.
Aspect 23. The thin film of aspect 22, wherein the second region(s) is/are circumjacent the first region(s).
Aspect 24. The thin film of any one of aspect 17 to 23, wherein the plurality of first regions and/or the plurality of second regions are dispersed in a matrix comprising a poly-t-butylmethacrylate portion of the block copolymer.
Aspect 25. The thin film of aspect 24, wherein the poly-t-butylmethacrylate portion comprises at least one monomer wherein R² is hydrogen.
Aspect 26. A method of forming a thin film of a self-assembled block copolymer, the method comprising:
(i) providing a block copolymer (BCP) having one or more of the following structures—

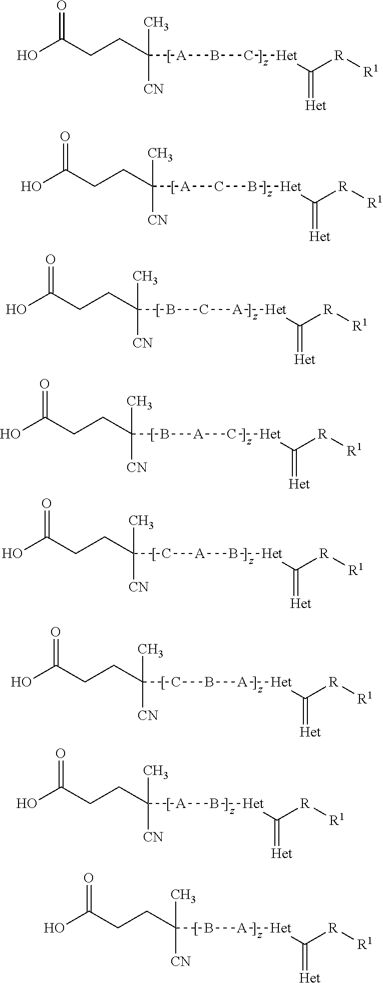

wherein z is at least 1,
wherein R¹ is selected independently from a C₁-C₂₀ hydrocarbyl,
wherein Het is selected from the group consisting of nitrogen, oxygen, and sulfur,
wherein R is selected from the group consisting of a divalent C₁ hydrocarbyl, nitrogen, oxygen, and sulfur,
wherein A is of the formula—

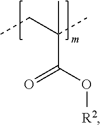

wherein each R² is selected independently from the group consisting of hydrogen and a C₁-C₂₀ hydrocarbyl,
wherein B is of the formula—

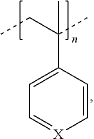

wherein each X is selected independently from N or N⁺R³, wherein R³ is selected independently from a C₁-C₂₀ hydrocarbyl,
wherein C is of the formula—

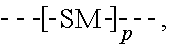

wherein SM is a stabilizer monomer, and
wherein m, n, and p are selected independently from an integer from 1 to 10,000; and
(ii) disposing the block copolymer on a substrate to form the thin film.
   Aspect 27. The method of aspect 26, further comprising:
(i) contacting the thin film with an amount of a quaternizing agent effective to quaternize at least one X to N⁺R³, wherein R³ is selected independently from a monovalent C₁-C₂₀ hydrocarbyl or a divalent C₁-C₂₀ hydrocarbyl crosslinker,
(ii) contacting the thin film with an amount of a hydrolyzing agent effective to hydrolyze at least one R² to hydrogen, or
(iii) a combination thereof.
   Aspect 28. A block copolymer as described herein.
   Aspect 29. A crosslinked block copolymer as described herein.
   Aspect 30. A film as described herein.
   Aspect 31. A method of forming a block copolymer or a film as described herein.

When used herein with regard to the selection of a substituent, the term “independently” indicates that (i) a substituent at a particular location may be the same or different for each molecule of a formula (e.g., a compound of formula (I) may include two molecules of formula (I), with each molecule having the same or a different C₁-C₂₀ hydrocarbyl selected for R¹), and/or (ii) two differently labeled substituents selected from the same pool of substituents may be the same or different (e.g., R¹ and R² of a block copolymer may both be selected from “a C₁-C₂₀ hydrocarbyl”, and the C₁-C₂₀ hydrocarbyls selected for R¹ and R² may be the same or different).

The phrase “C₁-C₂₀ hydrocarbyl,” and the like, as used herein, generally refer to aliphatic, aryl, or arylalkyl groups containing 1 to 20 carbon atoms. Examples of aliphatic groups, in each instance, include, but are not limited to, an alkyl group, a cycloalkyl group, an alkenyl group, a cycloalkenyl group, an alkynyl group, an alkadienyl group, a cyclic group, and the like, and includes all substituted, unsubstituted, branched, and linear analogs or derivatives thereof, in each instance having 1 to about 20 carbon atoms. Examples of alkyl groups include, but are not limited to, methyl, ethyl, propyl, isopropyl, n-butyl, t-butyl, isobutyl, pentyl, hexyl, isohexyl, heptyl, 4,4-dimethylpentyl, octyl, 2,2,4-trimethylpentyl, nonyl, decyl, undecyl and dodecyl. Cycloalkyl moieties may be monocyclic or multicyclic, and examples include cyclopropyl, cyclobutyl, cyclopentyl, cyclohexyl, and adamantyl. Additional examples of alkyl moieties have linear, branched and/or cyclic portions (e.g., 1-ethyl-4-methyl-cyclohexyl). Representative alkenyl moieties include vinyl, allyl, 1-butenyl, 2-butenyl, isobutylenyl, 1-pentenyl, 2-pentenyl, 3-methyl-1-butenyl, 2-methyl-2-butenyl, 2,3-dimethyl-2-butenyl, 1-hexenyl, 2-hexenyl, 3-hexenyl, 1-heptenyl, 2-heptenyl, 3-heptenyl, 1-octenyl, 2-octenyl, 3-octenyl, 1-nonenyl, 2-nonenyl, 3-nonenyl, 1-decenyl, 2-decenyl and 3-decenyl. Representative alkynyl moieties include acetylenyl, propynyl, 1-butynyl, 2-butynyl, 1-pentynyl, 2-pentynyl, 3-methyl-1-butynyl, 4-pentynyl, 1-hexynyl, 2-hexynyl, 5-hexynyl, 1-heptynyl, 2-heptynyl, 6-heptynyl, 1-octynyl, 2-octynyl, 7-octynyl, 1-nonynyl, 2-nonynyl, 8-nonynyl, 1-decynyl, 2-decynyl and 9-decynyl. Examples of aryl or arylalkyl moieties include, but are not limited to, anthracenyl, azulenyl, biphenyl, fluorenyl, indan, indenyl, naphthyl, phenanthrenyl, phenyl, 1,2,3,4-tetrahydro-naphthalene, tolyl, xylyl, mesityl, benzyl, and the like, including any heteroatom substituted derivative thereof.

The terms for various functional groups as used herein are not intended to be limited to monovalent radicals and may include polyvalent radical groups as appropriate, such as divalent, trivalent, tetravalent, pentavalent, and hexavalent groups, and the like, based on the position and location of such groups in the compounds described herein as would be readily understood by the skilled person.

“Alkyl” is a straight chain or branched saturated aliphatic hydrocarbon group. In certain aspects, the alkyl is C₁-C₂, C₁-C₃, or C₁-C₆ (i.e., the alkyl chain can be 1, 2, 3, 4, 5, or 6 carbons in length). The specified ranges as used herein indicate an alkyl group with length of each member of the range described as an independent species. For example, C₁-C₆alkyl as used herein indicates an alkyl group having from 1, 2, 3, 4, 5, or 6 carbon atoms and is intended to mean that each of these is described as an independent species and C₁-C₄alkyl as used herein indicates an alkyl group having from 1, 2, 3, or 4 carbon atoms and is intended to mean that each of these is described as an independent species. When C₀-Cₙalkyl is used herein in conjunction with another group, for example (C₃-C₇cycloalkyl)C₀-C₄alkyl, or -C₀-C₄(C₃-C₇cycloalkyl), the indicated group, in this case cycloalkyl, is either directly bound by a single covalent bond (C₀alkyl), or attached by an alkyl chain, in this case 1, 2, 3, or 4 carbon atoms. Alkyls can also be attached via other groups such as heteroatoms, as in —O-C₀-C₄alkyl(C₃-C₇cycloalkyl). Examples of alkyl include, but are not limited to, methyl, ethyl, n-propyl, isopropyl, n-butyl, isobutyl, sec-butyl, t-butyl, n-pentyl, isopentyl, tert-pentyl, neopentyl, n-hexyl, 2-methylpentane, 3-methylpentane, 2,2-dimethylbutane, and 2,3-dimethylbutane. In some aspects, the alkyl group is optionally substituted as described herein.

“Cycloalkyl” is a saturated or partially unsaturated mono- or multi-cyclic hydrocarbon ring system. When composed of two or more rings, the rings may be joined together in a fused or bridged fashion. Non-limiting examples of typical cycloalkyl groups include cyclopropyl, cyclobutyl, cyclopentyl, cyclohexyl, and cycloheptyl. In some aspects, the cycloalkyl group is optionally substituted as described herein.

“Alkenyl” is a straight or branched chain aliphatic hydrocarbon group having one or more carbon-carbon double bonds, each of which is independently either cis or trans, that may occur at a stable point along the chain. Non-limiting examples include C₂-C₄alkenyl and C₂-C₆alkenyl (i.e., having 2, 3, 4, 5, or 6 carbons). The specified ranges as used herein indicate an alkenyl group having each member of the range described as an independent species, as described above for the alkyl moiety. Examples of alkenyl include, but are not limited to, ethenyl and propenyl. In one aspect, the alkenyl group is optionally substituted as described herein.

“Alkynyl” is a straight or branched chain aliphatic hydrocarbon group having one or more carbon-carbon triple bonds that may occur at any stable point along the chain, for example, C₂-C₄alkynyl or C₂-C₆alkynyl (i.e., having 2, 3, 4, 5, or 6 carbons). The specified ranges as used herein indicate an alkynyl group having each member of the range described as an independent species, as described above for the alkyl moiety. Examples of alkynyl include, but are not limited to, ethynyl, propynyl, 1-butynyl, 2-butynyl, 3-butynyl, 1-pentynyl, 2-pentynyl, 3-pentynyl, 4-pentynyl, 1-hexynyl, 2-hexynyl, 3-hexynyl, 4-hexynyl, and 5-hexynyl. In one aspect, the alkynyl group is optionally substituted as described herein.

“Aryl” indicates an aromatic group containing only carbon in the aromatic ring or rings. In one aspect, the aryl group contains 1 to 3 separate or fused rings and is 6 to 14 or 18 ring atoms, without heteroatoms as ring members. When indicated, such aryl groups may be further substituted with carbon or non-carbon atoms or groups. Such substitution may include fusion to a 4- to 7- or 5- to 7-membered saturated or partially unsaturated cyclic group that optionally contains 1, 2, or 3 heteroatoms independently selected from N, O, B, P, Si and S, to form, for example, a 3,4-methylenedioxyphenyl group. Aryl groups include, for example, phenyl and naphthyl, including 1-naphthyl and 2-naphthyl. In one aspect, aryl groups are pendant. An example of a pendant ring is a phenyl group substituted with a phenyl group. In one aspect, the aryl group is optionally substituted as described herein.

The term “heterocycle” refers to saturated and partially saturated heteroatom-containing ring radicals, where the heteroatoms may be selected from N, O, and S. The term heterocycle includes monocyclic 3-12 members rings, as well as bicyclic 5-16 membered ring systems (which can include fused, bridged, or spiro bicyclic ring systems). It does not include rings containing —O—O—, —O—S—, and —S—S— portions. Examples of saturated heterocycle groups including saturated 4- to 7-membered monocyclic groups containing 1 to 4 nitrogen atoms [e.g., pyrrolidinyl, imidazolidinyl, piperidinyl, pyrrolinyl, azetidinyl, piperazinyl, and pyrazolidinyl]; saturated 4- to 6-membered monocyclic groups containing 1 to 2 oxygen atoms and 1 to 3 nitrogen atoms [e.g., morpholinyl]; and saturated 3- to 6-membered heteromonocyclic groups containing 1 to 2 sulfur atoms and 1 to 3 nitrogen atoms [e.g., thiazolidinyl]. Examples of partially saturated heterocycle radicals include, but are not limited, dihydrothienyl, dihydropyranyl, dihydrofuryl, and dihydrothiazolyl. Examples of partially saturated and saturated heterocycle groups include, but are not limited to, pyrrolidinyl, imidazolidinyl, piperidinyl, pyrrolinyl, pyrazolidinyl, piperazinyl, morpholinyl, tetrahydropyranyl, thiazolidinyl, dihydrothienyl, 2,3-dihydro-benzo[1,4]dioxanyl, indolinyl, isoindolinyl, dihydrobenzothienyl, dihydrobenzofuryl, isochromanyl, chromanyl, 1,2-dihydroquinolyl, 1,2,3,4-tetrahydro-isoquinolyl, 1,2,3,4-tetrahydro-quinolyl, 2,3,4,4a,9,9a-hexahydro-1H-3-aza-fluorenyl, 5,6,7-trihydro-1,2,4-triazolo[3,4-a]isoquinolyl, 3,4-dihydro-2H-benzo[1,4]oxazinyl, benzo[1,4]dioxanyl, 2,3,-dihydro-1H-benzo[d]isothazol-6-yl, dihydropyranyl, dihydrofuryl, and dihydrothiazolyl. Bicyclic heterocycle includes groups wherein the heterocyclic radical is fused with an aryl radical wherein the point of attachment is the heterocycle ring. Bicyclic heterocycle also includes heterocyclic radicals that are fused with a carbocyclic radical. Representative examples include, but are not limited to, partially unsaturated condensed heterocyclic groups containing 1 to 5 nitrogen atoms, for example indoline and isoindoline, partially unsaturated condensed heterocyclic groups containing 1 to 2 oxygen atoms and 1 to 3 nitrogen atoms, partially unsaturated condensed heterocyclic groups containing 1 to 2 sulfur atoms and 1 to 3 nitrogen atoms, and saturated condensed heterocyclic groups containing 1 to 2 oxygen or sulfur atoms.

“Heteroaryl” refers to a stable monocyclic, bicyclic, or multicyclic aromatic ring which contains from 1 to 4, or in some aspects 1, 2, or 3 heteroatoms selected from N, O, S, B, and P (and typically selected from N, O, and S) with remaining ring atoms being carbon, or a stable bicyclic or tricyclic system containing at least one 5, 6, or 7 membered aromatic ring which contains from 1 to 4, or in some aspects from 1 to 3 or from 1 to 2, heteroatoms selected from N, O, S, B, or P, with remaining ring atoms being carbon. In one aspects, the only heteroatom is nitrogen. In one aspect, the only heteroatom is oxygen. In one aspect, the only heteroatom is sulfur. Monocyclic heteroaryl groups typically have from 5 to 6 ring atoms. In some aspects, bicyclic heteroaryl groups are 8- to 10-membered heteroaryl groups, that is groups containing 8 or 10 ring atoms in which one 5-, 6-, or 7-membered aromatic ring which contains from 1 to 4 heteroatoms selected from N, O, S, B, or P is fused to a second aromatic or non-aromatic ring, wherein the point of attachment is an aromatic ring. When the total number of S and O atoms in the heteroaryl ring exceeds 1, these heteroatoms are not adjacent to one another within the ring. In one aspect, the total number of S and O atoms in the heteroaryl ring is not more than 2. In another aspect, the total number of S and O atoms in the heteroaryl ring is not more than 1. Examples of heteroaryl groups include, but are not limited to, pyridinyl, imidazolyl, imidazopyridinyl, pyrimidinyl, pyrazolyl, triazolyl, pyrazinyl, furyl, thienyl, isoxazolyl, thiazolyl, oxadiazolyl, oxazolyl, isothiazolyl, pyrrolyl, quinolinyl, isoquinolinyl, tetrahydroisoquinolinyl, indolyl, benzimidazolyl, benzofuranyl, cinnolinyl, indazolyl, indolizinyl, phthalazinyl, pyridazinyl, triazinyl, isoindolyl, pteridinyl, purinyl, triazolyl, thiadiazolyl, furazanyl, benzofurazanyl, benzothiophenyl, benzothiazolyl, benzoxazolyl, quinazolinyl, quinoxalinyl, naphthyridinyl, and furopyridinyl.

A dash (“-”) that is not between two letters or symbols is used to indicate a point of attachment for a substituent. For example, —(C═O)NH₂ is attached through the carbon of the keto (C═O) group.

Unless otherwise indicated, the term “substituted,” when used to describe a chemical structure or moiety, refers to a derivative of that structure or moiety wherein one or more of its hydrogen atoms is substituted with a chemical moiety or functional group such as alcohol, alkoxy, alkanoyloxy, alkoxycarbonyl, alkenyl, alkyl (e.g., methyl, ethyl, propyl, t-butyl), alkynyl, alkylcarbonyloxy (—OC(O)alkyl), amide (—C(O)NH-alkyl- or -alkylNHC(O)alkyl), tertiary amine (such as alkylamino, arylamino, arylalkylamino), aryl, aryloxy, azo, carbamoyl (—NHC(O)Oalkyl- or —OC(O)NH-alkyl), carbamyl (e.g., CONH₂, as well as CONH-alkyl, CONH-aryl, and CONH-arylalkyl), carboxyl, carboxylic acid, cyano, ester, ether (e.g., methoxy, ethoxy), halo, haloalkyl (e.g., —CCl₃, —CF₃, —C(CF₃)₃), heteroalkyl, isocyanate, isothiocyanate, nitrile, nitro, phosphodiester, sulfide, sulfonamido (e.g., SO₂NH₂), sulfone, sulfonyl (including alkylsulfonyl, arylsulfonyl and arylalkylsulfonyl), sulfoxide, thiol (e.g., sulfhydryl, thioether) or urea (—NHCONH-alkyl-).

All referenced publications are incorporated herein by reference in their entirety.

Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of various aspects, applicants in no way disclaim these technical aspects, and it is contemplated that the present disclosure may encompass one or more of the conventional technical aspects discussed herein.

The present disclosure may address one or more of the problems and deficiencies of known methods and processes. However, it is contemplated that various aspects may prove useful in addressing other problems and deficiencies in a number of technical areas. Therefore, the present disclosure should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

In the descriptions provided herein, the terms “includes,” “is,” “containing,” “having,” and “comprises” are used in an open-ended fashion, and thus should be interpreted to mean “including, but not limited to.” When block copolymers, thin films, or methods are claimed or described in terms of “comprising” various steps or components, the block copolymers, thin films, or methods can also “consist essentially of” or “consist of” the various steps or components, unless stated otherwise.

The terms “a,” “an,” and “the” are intended to include plural alternatives, e.g., at least one. For instance, the disclosure of “a thin film,” “a block copolymer,” “a monomer”, and the like, is meant to encompass one, or mixtures or combinations of more than one thin film, block copolymer, monomer, and the like, unless otherwise specified.

Various numerical ranges may be disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Moreover, all numerical end points of ranges disclosed herein are approximate. As a representative example, Applicant discloses, in some aspects, that the ratio of m to n is about 1:1 to about 1.5:1. This range should be interpreted as encompassing about 1:1 and about 1.5:1, and further encompasses “about” each of 1.1:1, 1.2:1, 1.3:1, and 1.4:1, including any ranges and sub-ranges between any of these values.

As used herein, the term “about” means plus or minus 10% of the numerical value of the number with which it is being used.

### EXAMPLES

The present invention is further illustrated by the following examples, which are not to be construed in any way as imposing limitations upon the scope thereof. On the contrary, it is to be clearly understood that resort may be had to various other aspects, modifications, and equivalents thereof which, after reading the description herein, may suggest themselves to one of ordinary skill in the art without departing from the spirit of the present invention or the scope of the appended claims. Thus, other aspects of this invention will be apparent to those skilled in the art from consideration of the specification and practice of the invention disclosed herein.

### Example 1—Synthesis of Block Copolymer

In this example, an representative block copolymer is made according to a reversible addition-fragmentation chain-transfer (RAFT) process, such as the one shown in the following scheme.

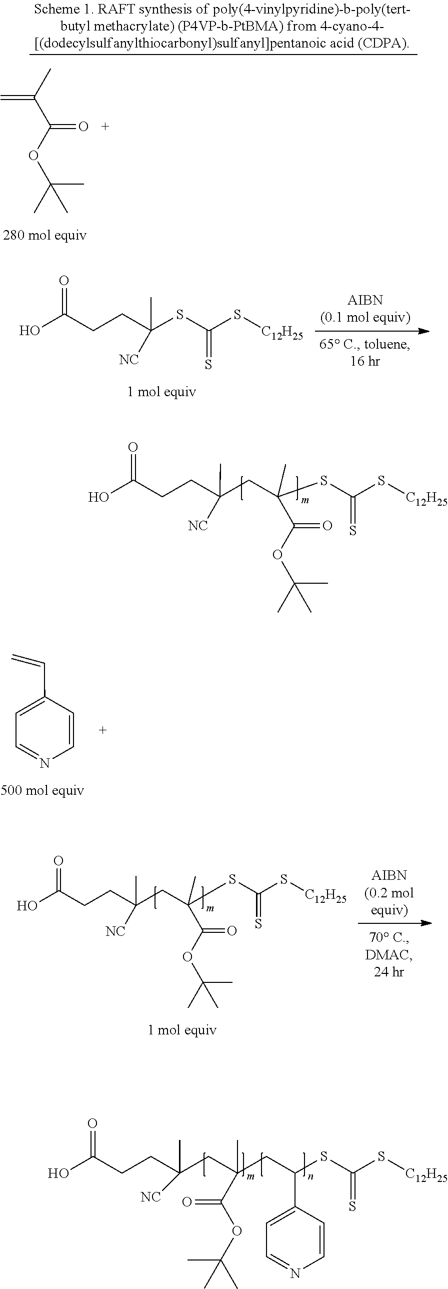

Prior to the addition of vinyl pyridine, however, a stabilizer monomer is added, which is not shown in the foregoing scheme.

### Example 2—Thin Film Preparation

Silicon wafers are prepared by submerging them in piranha solution for 2 hours at 150° C. Wafers are removed from solution and thoroughly rinsed with DI water before drying fully under a stream of N₂. A 20 mg/mL solution of polymer in CHCl₃ is spun cast onto each wafer at 3000 RPM for 30 seconds.

Vapor annealing treatment is performed by storing film-coated wafers in a sealed glass chamber along with 10 mL of CHCl₃ in a separate vial. The films are exposed to CHCl₃ vapor for 8 hours. The chamber seal is then opened and CHCl₃ is allowed to evaporate from the chamber before removing.

Solvent vapor annealing is an effective method for producing perpendicularly aligned morphologies on the surface of the thin films. To determine a good solvent choice for this technique, AFM images are taken following different solvent vapor treatments (THF, DMF, CHCl₃) with varying exposure and evaporation times. It is determined that about 8 hours of CHCl₃ vapor treatment followed by slow vapor purging of the chamber consistently produces a hexagonally-packed cylindrical morphology perpendicular to the air-film interface, as depicted at FIG. 1.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

What is claimed is:

1. A block copolymer of formula A, formula B, formula C, formula D, formula E, or formula F: 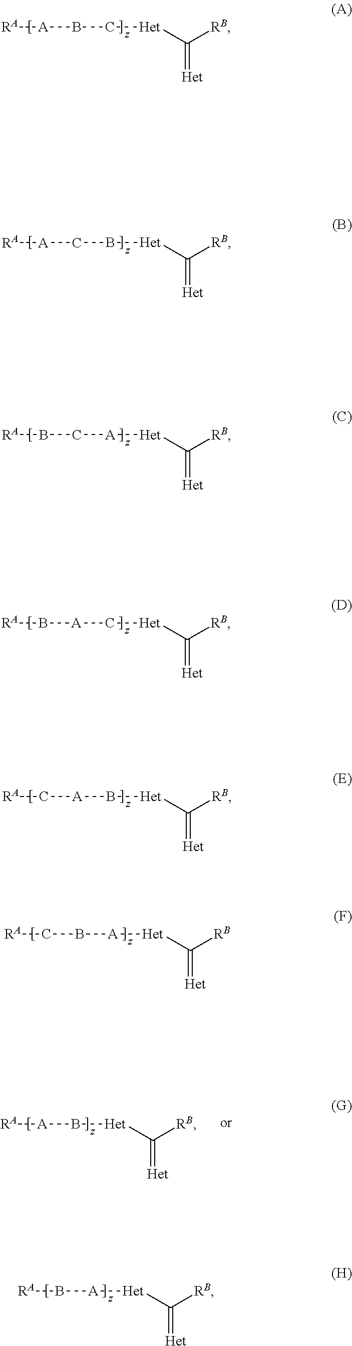
wherein:
R^{A} is independently selected at each occurrence selected from 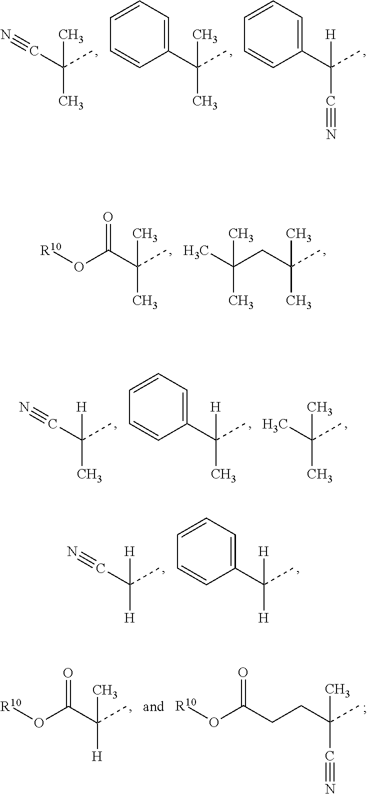
R¹⁰ is independently selected at each occurrence from hydrogen and C₁-C₂₀ hydrocarbyl;
R^{B} is independently selected at each occurrence from selected from 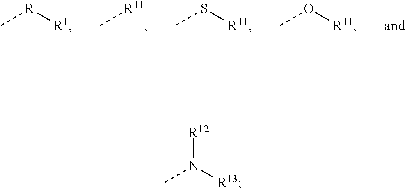
R is independently selected at each occurrence from divalent C₁ hydrocarbyl, nitrogen, oxygen, and sulfur;
R¹ is independently selected at each occurrence from C₁-C₂₀ hydrocarbyl;
R¹¹ is independently selected at each occurrence from C₁-C₂₀ hydrocarbyl;
R¹² is independently selected at each occurrence from hydrogen and C₁-C₂₀ hydrocarbyl;
R¹³ is independently selected at each occurrence from C₁-C₂₀ hydrocarbyl;
or R¹² and R¹³ are brought together with the carbon to which they are attached to form a 5- to 6-membered heterocycle or 5- to 10-membered monocyclic or bicyclic heteroaryl;
z is at least 1;
Het is independently selected at each occurrence from NH, O, or S;
A is 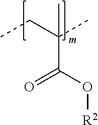
wherein each R² is independently selected at each occurrence from hydrogen and C₁-C₂₀ hydrocarbyl,
B is 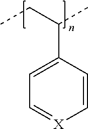
wherein X is independently selected at each occurrence from N or N⁺R³, wherein R³ is independently selected at each occurrence from a monovalent C₁-C₂₀ hydrocarbyl or a divalent C₁-C₂₀ hydrocarbyl crosslinker,
C is 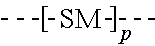
wherein SM is a stabilizer monomer, and
m, n, and p are independently selected from an integer from 1 to 10,000.

2. The block copolymer of claim 1, wherein R^{A} is 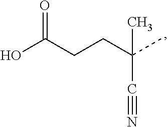
and
R^{B} is

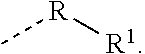

3. The block copolymer of claim 2, wherein R¹ is unsubstituted linear C₁₂ hydrocarbyl.

4. The block copolymer of claim 1, wherein wherein R² is tert-butyl.

5. The block copolymer of claim 1, wherein C is 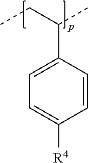
wherein R⁴ is independently selected at each occurrence from hydrogen and C₁-C₂₀ hydrocarbyl.

6. The block copolymer of claim 5, wherein R⁴ is hydrogen.

7. The block copolymer of claim 5, wherein R⁴ is tert-butyl.

8. The block copolymer of claim 1, wherein X is N.

9. The block copolymer of claim 1, wherein X is N⁺R³, wherein R³ is a divalent C₁-C₂₀ hydrocarbyl crosslinker.

10. The block copolymer of claim 1, having the structure

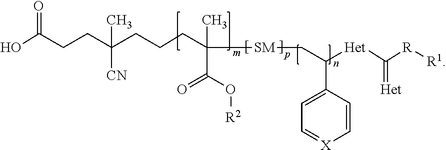

11. The block copolymer of claim 1, having the structure

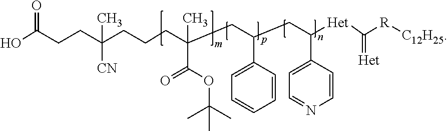

12. A thin film comprising the block copolymer of claim 1.

13. The thin film of claim 12, wherein the thin film comprises a plurality of first regions consisting of a poly-4-vinylpyridine portion of the block copolymer.

14. The thin film of claim 13, wherein the thin film comprises a plurality of second regions consisting of a stabilizing monomer portion of the block copolymer.

15. The thin film of claim 14, wherein second regions are circumjacent to the first regions.

16. The thin film of claim 15, wherein the plurality of first regions and the plurality of second regions are dispersed in a matrix comprising a poly-t-butylmethacrylate portion of the block copolymer.

17. A method of forming a thin film of a self-assembled block copolymer, the method comprising:
(i) providing a block copolymer of claim 1,
(ii) disposing the block copolymer on a substrate to form the thin film.

18. A method of producing a block copolymer comprising
(i) providing a compound of formula (I-a) 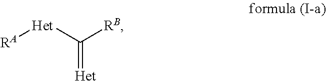
wherein
R^{A} is independently selected at each occurrence selected from 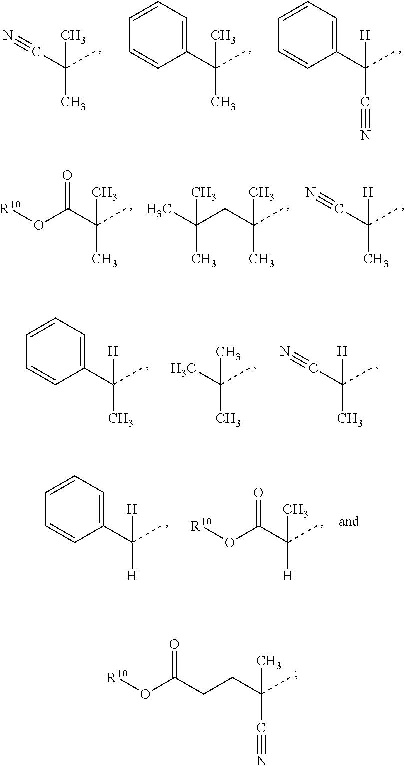
R¹⁰ is independently selected at each occurrence from hydrogen and C₁-C₂₀ hydrocarbyl;
R^{B} is independently selected at each occurrence from selected from 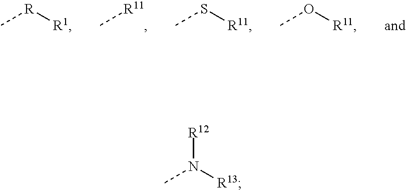
R is independently selected at each occurrence from divalent C₁ hydrocarbyl, nitrogen, oxygen, and sulfur;
R¹ is independently selected at each occurrence from C₁-C₂₀ hydrocarbyl;
R¹¹ is independently selected at each occurrence from C₁-C₂₀ hydrocarbyl;
R¹² is independently selected at each occurrence from hydrogen and C₁-C₂₀ hydrocarbyl; and
R¹³ is independently selected at each occurrence from C₁-C₂₀ hydrocarbyl;
or R¹² and R¹³ are brought together with the carbon to which they are attached to form a 5- to 6-membered heterocycle or 5- to 10-membered monocyclic or bicyclic heteroaryl;
(ii) providing a compound of formula (II) 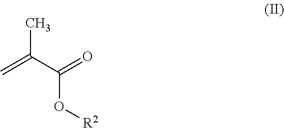
wherein R² is selected from hydrogen and C₁-C₂₀ hydrocarbyl;
(iii) providing a stabilizer monomer;
(iv) contacting the compound of formula (I-a), the compound of formula (II), and the stabilizer monomer to form an intermediate polymer; and
(v) contacting the intermediate polymer with a vinylpyridine to form the block copolymer.

19. The method of claim 18, wherein the compound of formula (I-a) is a compound of formula (I)

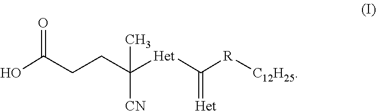

20. The method of claim 18, wherein the stabilizer monomer is selected from styrene, a styrenic derivative, a C₂-C₆ alkene, polyvinyl halide, or a combination thereof.
